(19) United States
(12) Patent Application Publication
(10) Pub. No.: US 2025/0028149 A1
(43) Pub. Date: Jan. 23, 2025

(54) OPTICAL ELEMENT DRIVING MECHANISM

(71) Applicant: TDK TAIWAN CORP., Taoyuan City (TW)

(72) Inventors: Wei-Jhe SHEN, Taoyuan City (TW); Sin-Jhong SONG, Taoyuan City (TW)

(21) Appl. No.: 18/778,603

(22) Filed: Jul. 19, 2024

Related U.S. Application Data
(60) Provisional application No. 63/514,958, filed on Jul. 21, 2023.

(51) Int. Cl. G02B 7/08; G02B 27/64

(52) U.S. Cl. CPC G02B 7/08; G02B 27/646

(57) ABSTRACT

An optical element driving mechanism includes a fixed assembly, a movable assembly and a driving module. The movable assembly is configured to be connected to an optical element, and the movable assembly is movable relative to the fixed assembly. The driving module is configured to drive the movable assembly to move relative to the fixed assembly.

### CROSS REFERENCE TO RELATED APPLICATIONS

This application claims the benefit of U.S. Provisional Application No. 63/514,958, filed on Jul. 21, 2023, the entirety of which is incorporated by reference herein.

### BACKGROUND OF THE INVENTION

### Field of the Disclosure

The present disclosure relates to an optical element driving mechanism, and in particular to a lightweight and miniaturized optical element driving mechanism.

### Description of the Related Art

The development of technology has allowed many of today's electronic devices (such as smartphones) to be equipped with cameras to provide photographic and video functionality. Users can capture photographs and record videos using the camera modules disposed in their electronic devices.

Today's design of electronic devices continues to follow the trend of miniaturization, meaning that the various components of the camera module and its structure must also be continuously reduced, so as to achieve miniaturization. In general, a driving mechanism in a camera module has a camera lens holder configured to hold a camera lens, and the driving mechanism can have the functions of auto focusing and optical image stabilization. However, although the existing driving mechanism can achieve the aforementioned functions of taking photographs and recording videos, they still cannot meet all users' needs.

Therefore, how to design a camera module that can perform autofocus and optical anti-shake and achieve miniaturization at the same time is topic nowadays that needs to be discussed and solved.

### BRIEF SUMMARY OF THE INVENTION

Accordingly, one objective of the present disclosure is to provide an optical element driving mechanism to solve the above problems.

According to some embodiments of the disclosure, an optical element driving mechanism includes a fixed assembly, a movable assembly, and a driving module. The movable assembly is configured to be connected to an optical element, and the movable assembly is movable relative to the fixed assembly. The driving module is configured to drive the movable assembly to move relative to the fixed assembly.

According to some embodiments, the fixed assembly includes a casing and a base. The casing and the base are arranged along a main axis. The optical element driving mechanism further includes a first circuit assembly. The first circuit assembly has a body portion, and the optical element is disposed on the body portion. The body portion is connected to the movable assembly. The first circuit assembly further has a cantilever which is connected between the body portion and the casing. The driving module is configured to drive the movable assembly, the body portion and the optical element to move.

According to some embodiments, the driving module includes a first driving assembly configured to drive the movable assembly to move along the main axis. The movable assembly includes a pedestal and a movable part. The driving module further includes a second driving assembly configured to drive the movable part to move along a first axis relative to the pedestal. The driving module further includes a third driving assembly configured to drive the movable part to move along a second axis relative to the pedestal. The first axis is perpendicular to the main axis. The second axis is perpendicular to the first axis and the main axis.

According to some embodiments, the optical element driving mechanism further includes a second circuit assembly which is fixedly disposed on the movable assembly. The second circuit assembly is disposed on a side wall of the pedestal. The first driving assembly includes a first magnetic element and a first driving element. One of the first magnetic element and the first driving element is disposed on the second circuit assembly, and the other one of the first magnetic element and the first driving element is disposed on the base correspondingly. The first driving element is configured to react with the first magnetic element to generate a first electromagnetic driving force to drive the movable assembly to move along the main axis.

According to some embodiments, the optical element driving mechanism further includes a third circuit assembly which is disposed on a bottom plate of the pedestal. The second driving assembly includes a second magnetic element and a second driving element. One of the second magnetic element and the second driving element is disposed on the third circuit assembly, and the other one of the second magnetic element and the second driving element is disposed on the movable part correspondingly. The second driving element is configured to react with the second magnetic element to generate a second electromagnetic driving force to drive the movable part to move along the first axis relative to the pedestal. The third driving assembly includes a third magnetic element and a third driving element. One of the third magnetic element and the third driving element is disposed on the third circuit assembly, and the other one of the third magnetic element and the third driving element is disposed on the movable part correspondingly. The third driving element is configured to react with the third magnetic element to generate a third electromagnetic driving force to drive the movable part to move along the second axis relative to the pedestal.

According to some embodiments, the driving module further includes a fourth driving assembly. The fourth driving assembly includes a fourth driving element. The fourth driving element is disposed on the third circuit assembly or the movable part. The fourth driving element is configured to react with the second magnetic element to generate a fourth electromagnetic driving force. When the second electromagnetic driving force is opposite to the fourth electromagnetic driving force, the second electromagnetic driving force and the fourth electromagnetic driving force are configured to drive the movable part to rotate around the main axis.

According to some embodiments, the optical element driving mechanism further includes a first driving circuit and a second driving circuit, which are respectively disposed on the second circuit assembly and the third circuit assembly. The first driving circuit is electrically connected to the first driving element. The second driving circuit is electrically connected to the second driving element, the third driving element and the fourth driving element. The optical element driving mechanism further includes a plurality of first conductive members which are disposed in the pedestal. The second circuit assembly is electrically connected to the third circuit assembly through the first conductive members. The first driving circuit is electrically connected to the second driving circuit through the first conductive members and the third circuit assembly.

According to some embodiments, the optical element driving mechanism further includes a plurality of second conductive members, which are disposed in the pedestal. The optical element driving mechanism further includes a plurality of elastic members which are movably connected between the pedestal and the base. The third circuit assembly is electrically connected to the elastic members through the second conductive members. The optical element driving mechanism further includes a plurality of third conductive members which are partially disposed in the base. The second conductive members, the elastic members and the third conductive members form a plurality of external lines. The first driving circuit and the second driving circuit share the external lines.

According to some embodiments, the first driving circuit and the second driving circuit are electrically connected to an external control circuit through the external lines. The first driving circuit controls the operation of the first driving element according to a first control signal sent by the external control circuit. The second driving circuit controls the operation of the second driving element, the third driving element and the fourth driving element according to a second control signal sent by the external control circuit. The first driving circuit is configured to sense movement of the movable assembly relative to the base.

According to some embodiments, the optical element driving mechanism further includes a first sensor, a second sensor and a third sensor, which are electrically connected to the second driving circuit. The first sensor, the second sensor and the third sensor are disposed on the third circuit assembly. The first sensor is configured to sense the movement of the movable part along the first axis relative to the pedestal. The second sensor is configured to sense the movement of the movable part relative to the pedestal along the second axis. The third sensor is configured to sense rotation of the movable part relative to the pedestal around the main axis.

According to some embodiments, the optical element driving mechanism further includes a first guiding member disposed between the base and the movable assembly. The first guiding member is configured to guide the movable assembly to move along the main axis. The optical element driving mechanism further includes a first attraction element which is disposed in the pedestal. The first attraction element is made of magnetic material. The first guiding member is made of metal.

According to some embodiments, a first magnetic attraction force is generated between the first attraction element and the first guiding member to drive the pedestal to bear against the first guiding member. The first guiding member has a long strip-shaped structure. The length of the first guiding member is greater than the length of the first attraction element on the main axis.

According to some embodiments, the optical element driving mechanism further includes at least one second attraction element which is disposed in the pedestal and corresponds to the second magnetic element. When viewed along the main axis, the second attraction element has a long strip-shaped structure. The extending direction of the second attraction element is different from the extending direction of the second magnetic element. The extending direction of the second attraction element is perpendicular to the extending direction of the second magnetic element.

According to some embodiments, when viewed along the main axis, the length of the second attraction element on the first axis is different from the width of the second magnetic element on the first axis. When viewed along the main axis, the length of the second attraction element on the first axis is greater than the width of the second magnetic element on the first axis. The second attraction element and the second magnetic element are configured to generate a second magnetic attraction force.

According to some embodiments, the optical element driving mechanism further includes at least one third attraction element, which is disposed in the pedestal and corresponds to the third magnetic element. When viewed along the main axis, the third attraction element has a long strip-shaped structure. The extending direction of the third attraction element is different from the extending direction of the third magnetic element. The extending direction of the third attraction element is perpendicular to the extending direction of the third magnetic element.

According to some embodiments, when viewed along the main axis, the length of the third attraction element on the second axis is different from the width of the third magnetic element on the second axis. When viewed along the main axis, the length of the third attraction element on the second axis is greater than the width of the third magnetic element on the second axis. The third attraction element and the third magnetic element are configured to generate a third magnetic attraction force.

According to some embodiments, the optical element driving mechanism further includes a plurality of second guiding members, which are disposed between the pedestal and the movable part. The movable part moves relative to the pedestal through the second guiding members. The movable part has a plurality of accommodation grooves configured to accommodate the second guiding members respectively. When viewed along the main axis, each of the accommodation grooves has a circular structure. Each of the second guiding members has a spherical structure.

According to some embodiments, when viewed along the main axis, the size of the accommodation groove is greater than the size of the corresponding second guiding member. The material of the second guiding members is different from the material of the movable part. The young's modulus of the second guiding members is different from the young's modulus of the movable part. The Young's modulus of the second guiding members is more than ten times of the Young's modulus of the movable part. The movable part is made of a plastic material. The second guiding members are made of ceramic materials.

According to some embodiments, the optical element driving mechanism further includes a first optical module, which is detachably connected to a casing of the fixed assembly. The first optical module has a first optical element and at least one first driving member. The first driving member is configured to drive the first optical element to move along an optical axis of the first optical element relative to the casing. The optical element driving mechanism further includes a second optical module and a connecting member. The second optical module is detachably connected to the casing via the connecting member.

According to some embodiments, the second optical module surrounds at least a portion of the first optical module. The second optical module has an aperture structure. The connecting member is disposed on the casing by insert molding technology. The casing is made of metal. The connecting member is made of a plastic material.

The present disclosure provides an optical element driving mechanism, which includes a fixed assembly, a movable assembly and a driving module. The movable assembly is configured to be connected to an optical element, and the driving module is configured to drive the movable assembly to move relative to the fixed assembly. The driving module may include a first driving assembly configured to drive the movable assembly to move along the optical axis relative to the fixed assembly so as to achieve the automatic focusing.

In some embodiments, the optical element driving mechanism may further include two first guiding members which are disposed between the base and the movable assembly and configured to guide the movable assembly to move along the main axis relative to base. The optical element driving mechanism may further include two first attraction elements, which are disposed in the pedestal of the movable assembly. A first magnetic attraction force can be generated between the first attraction element and the corresponding first guiding member to drive the pedestal to bear against the first guiding member. Based on such a configuration, the movable assembly can be more stable when moving along the main axis.

In addition, the optical element driving mechanism may further include a plurality of second guiding members, the movable assembly may have the aforementioned pedestal and a movable part, and the movable part can move relative to the pedestal through the second guiding members. The driving module may include a second driving assembly and a third driving assembly, which are partially disposed on the pedestal. When the optical element driving mechanism is shaken, the second driving assembly and the third driving assembly can drive the movable part to move on the X-Y plane to achieve the purpose of optical image stabilization.

Additional features and advantages of the disclosure will be set forth in the description which follows, and, in part, will be obvious from the description, or can be learned by practice of the principles disclosed herein. The features and advantages of the disclosure can be realized and obtained by means of the instruments and combinations pointed out in the appended claims. These and other features of the disclosure will become more fully apparent from the following description and appended claims, or can be learned by the practice of the principles set forth herein.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic diagram of an optical element driving mechanism 100 according to an embodiment of the present disclosure.

FIG. 2 is an exploded diagram of the optical element driving mechanism 100 according to an embodiment of the present disclosure.

FIG. 3 is a cross-sectional view of the optical element driving mechanism 100 along line A-A in FIG. 1 according to an embodiment of the present disclosure.

FIG. 4 is an exploded diagram of the movable assembly MA according to an embodiment of the present disclosure.

FIG. 5 is a perspective view of a partial structure of the optical element driving mechanism 100 according to an embodiment of the present disclosure.

FIG. 6 is a cross-sectional view of the optical element driving mechanism 100 along line B-B in FIG. 1 according to an embodiment of the present disclosure.

FIG. 7 is a bottom view of a partial structure of the optical element driving mechanism 100 according to an embodiment of the present disclosure.

FIG. 8 is a top view of a partial structure of the optical element driving mechanism 100 according to an embodiment of the present disclosure.

FIG. 9 is a perspective view of a partial structure of the optical element driving mechanism 100 according to an embodiment of the present disclosure.

FIG. 10 is a functional block diagram of a partial structure of the optical element driving mechanism 100 according to an embodiment of the present disclosure.

FIG. 11 is a schematic front view of a partial structure of the optical element driving mechanism 100 according to an embodiment of the present disclosure.

### DETAILED DESCRIPTION OF THE INVENTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are in direct contact, and may also include embodiments in which additional features may be disposed between the first and second features, such that the first and second features may not be in direct contact.

In addition, the present disclosure may repeat reference numerals and/or letters in the various examples. This repetition is for the purpose of simplicity and clarity and does not in itself dictate a relationship between the various embodiments and/or configurations discussed. Moreover, the formation of a feature on, connected to, and/or coupled to another feature in the present disclosure that follows may include embodiments in which the features are in direct contact, and may also include embodiments in which additional features may be disposed interposing the features, such that the features may not be in direct contact. In addition, spatially relative terms, for example, “vertical,” “above,” “over,” “below,”, “bottom,” etc. as well as derivatives thereof (e.g., “downwardly,” “upwardly,” etc.) are used in the present disclosure for ease of description of one feature's relationship to another feature. The spatially relative terms are intended to cover different orientations of the device, including the features.

Unless defined otherwise, all technical and scientific terms used herein have the same meaning as commonly understood by one of ordinary skill in the art to which this disclosure belongs. It should be appreciated that each term, which is defined in a commonly used dictionary, should be interpreted as having a meaning conforming to the relative skills and the background or the context of the present disclosure, and should not be interpreted in an idealized or overly formal manner unless defined otherwise.

Use of ordinal terms such as “first”, “second”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

In addition, in some embodiments of the present disclosure, terms concerning attachments, coupling and the like, such as “connected” and “interconnected”, refer to a relationship wherein structures are secured or attached to one another either directly or indirectly through intervening structures, as well as both movable or rigid attachments or relationships, unless expressly described otherwise.

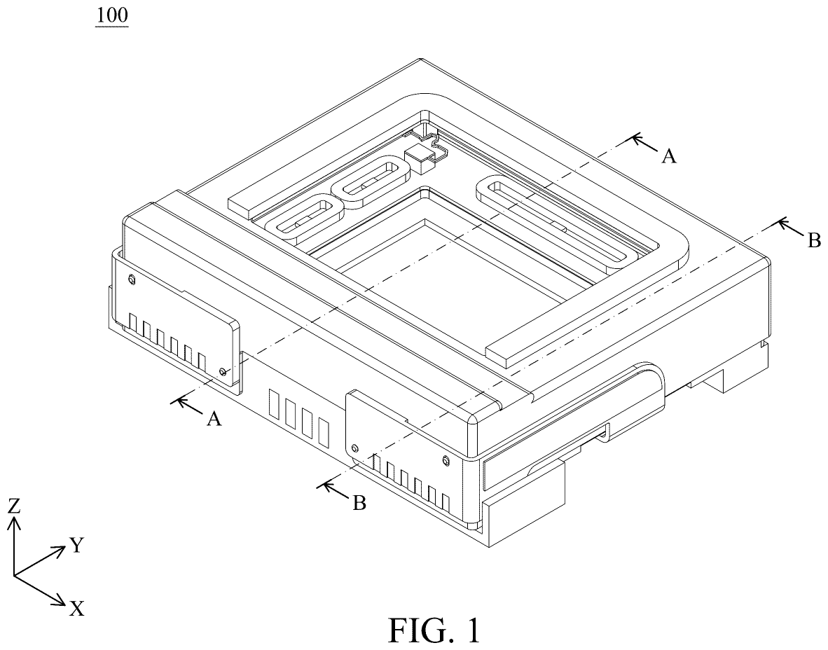

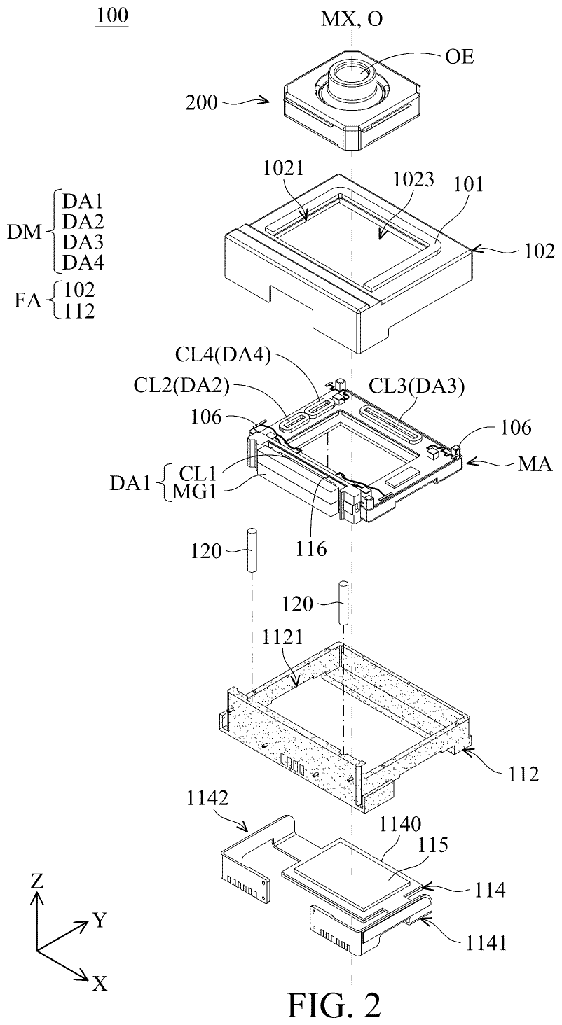

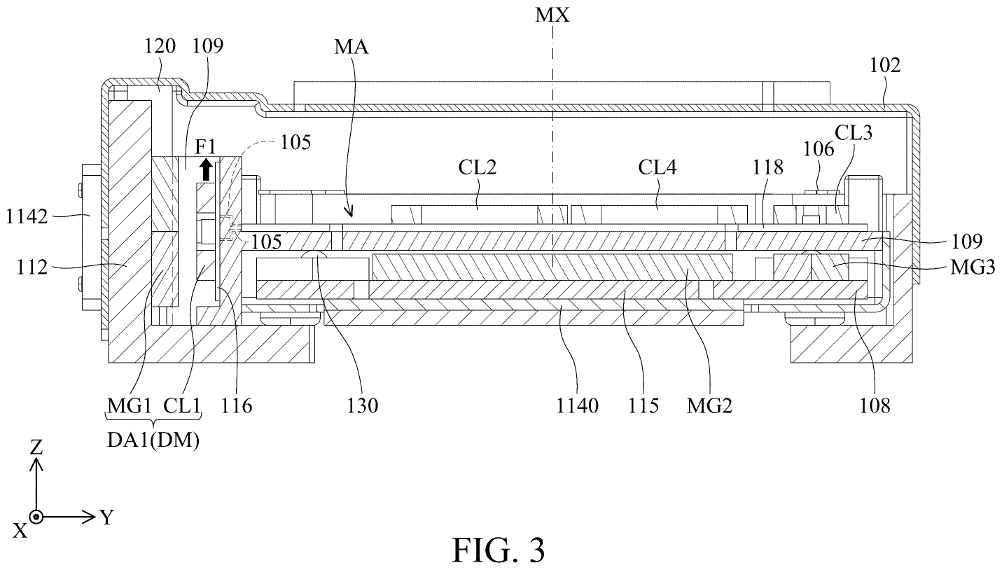

Please refer to FIG. 1 to FIG. 3. FIG. 1 is a schematic diagram of an optical element driving mechanism 100 according to an embodiment of the present disclosure, FIG. 2 is an exploded diagram of the optical element driving mechanism 100 according to an embodiment of the present disclosure, and FIG. 3 is a cross-sectional view of the optical element driving mechanism 100 along line A-A in FIG. 1 according to an embodiment of the present disclosure. The optical element driving mechanism 100 can be an optical camera module and can be configured to hold and drive an optical element. The optical element driving mechanism 100 can be installed in various electronic devices or portable electronic devices, such as a smartphone, for allowing a user to perform the image capturing function. In this embodiment, the optical element driving mechanism 100 may be a voice coil motor (VCM) with an autofocus (AF) function, but it is not limited thereto. In other embodiments, the optical element driving mechanism 100 can also perform the functions of auto-focusing and optical image stabilization (OIS).

In this embodiment, the optical element driving mechanism 100 may include a fixed assembly FA, a movable assembly MA, and a driving module DM. The movable assembly MA is configured to connect to an optical element 115, and the movable assembly MA is movable relative to the fixed assembly FA. The driving module DM is configured to drive the movable assembly MA to move relative to the fixed assembly FA.

In this embodiment, as shown in FIG. 2, the fixed assembly FA includes a casing 102 and a base 112, and the casing 102 and the base 112 are arranged along a main axis MX. Furthermore, the optical element driving mechanism 100 may further include a first optical module 200 which is disposed on the casing 102. Another optical element OE may be disposed in the first optical module 200, and the optical element OE is, for example, a camera lens, but it is not limited thereto.

As shown in FIG. 2, the optical element driving mechanism 100 may further include a first circuit assembly 114, and the optical element 115 is disposed on the first circuit assembly 114. In this embodiment, a portion of the first circuit assembly 114 is affixed to the casing 102, and another portion of the first circuit assembly 114 is connected to the movable assembly MA. The first circuit assembly 114 is, for example, a flexible circuit board, and the optical element 115 is, for example, a photosensitive element, but they are not limited thereto.

As shown in FIG. 2, the aforementioned casing 102 has a hollow structure, and a casing opening 1021 is formed on the casing 102. A base opening 1121 is formed on the base 112. The center of the casing opening 1021 corresponds to an optical axis O of the optical element OE, and the base opening 1121 corresponds to the optical element 115 disposed below the base 112. An external light can enter the casing 102 through the casing opening 1021 and to be received by the aforementioned optical element 115 after passing through the optical element OE and the base opening 1121 so as to generate a digital image signal.

Furthermore, when the casing 102 is disposed on the base 112, an accommodation space 1023 can be formed to accommodate the movable assembly MA, the driver module DM and a portion of the first circuit assembly 114.

As shown in FIG. 2, the first circuit assembly 114 has a body portion 1140, which has a plate-shaped structure, the optical element 115 is disposed on the body portion 1140, and the body portion 1140 is fixedly connected to the movable assembly MA.

The first circuit assembly 114 further has a cantilever 1141 and a cantilever 1142, which are connected between the body portion 1140 and the casing 102. Specifically, the cantilevers 1141 and 1142 extend from the body portion 1140, and a portion of the cantilevers 1141 and 1142 is affixed to the casing 102. In this embodiment, the body portion 1140 and the cantilevers 1141, 1142 are integrally formed as one piece.

In this embodiment, the driving module DM is configured to drive the movable assembly MA, the body portion 1140 and the optical element 115 to move along the main axis MX. As shown in FIG. 2 and FIG. 3, the optical element driving mechanism 100 may further include two first guiding members 120, which are disposed between the base 112 and the movable assembly MA.

Each of the first guiding members 120 may have a columnar structure or a long strip-shaped structure which extends along the main axis MX, and the first guiding members 120 are configured to guide the movable assembly MA to move along the main axis MX relative to the base 112.

In this embodiment, as shown in FIG. 2 and FIG. 3, the optical element driving mechanism 100 may further include a second circuit assembly 116, which is fixedly disposed on the movable assembly MA. The second circuit assembly 116 is, for example, a flexible circuit board, but it is not limited thereto.

Furthermore, the driving module DM may include a first driving assembly DA1 configured to drive the movable assembly MA to move along the main axis MX. Specifically, the first driving assembly DA1 may include a first magnetic element MG1 and a first driving element CL1. The first magnetic element MG1 is fixedly disposed on the base 112, and the first driving element CL1 is disposed on the second circuit assembly 116, but they are not limited thereto. In other embodiments, the positions of the first magnetic element MG1 and the first driving element CL1 can be interchanged.

The first magnetic element MG1 is, for example, a magnet, and the first driving element CL1 is, for example, a winding coil, but they are not limited thereto. The first driving element CL1 is configured to react with the first magnetic element MG1 to generate a first electromagnetic driving force F1 to drive the movable assembly MA to move back and forth along the main axis MX.

In addition, as shown in FIG. 2 and FIG. 3, the optical element driving mechanism 100 further includes a plurality of elastic members 106, which are movably connected between the movable assembly MA and the base 112. Therefore, the movable assembly MA can be suspended in the accommodation space 1023 through the elastic members 106.

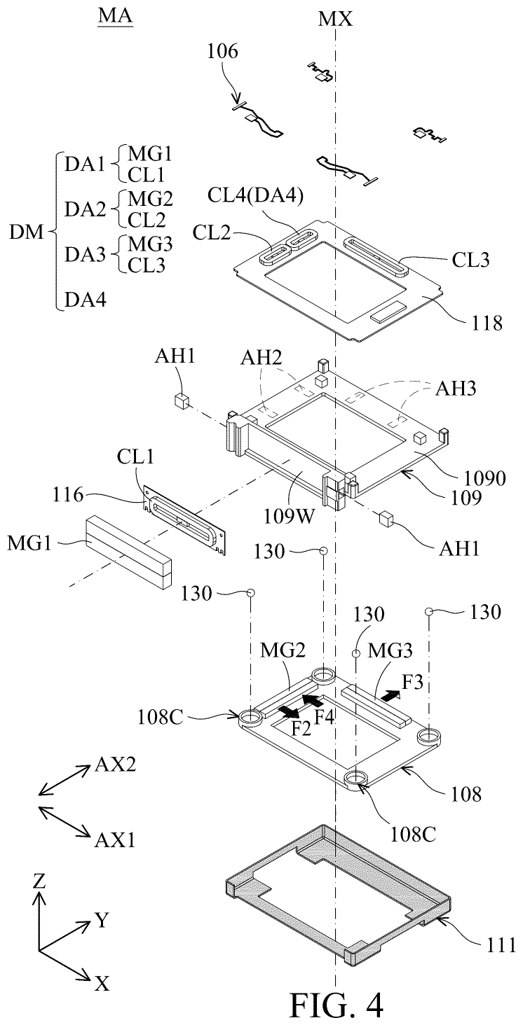

Next, please refer to FIG. 2 to FIG. 4. FIG. 4 is an exploded diagram of the movable assembly MA according to an embodiment of the present disclosure. In this embodiment, the movable assembly MA may include a pedestal 109 and a movable part 108, and as shown in FIG. 4, the second circuit assembly 116 is fixedly disposed on a side wall 109W of the pedestal 109.

Furthermore, the optical element driving mechanism 100 may further include a third circuit assembly 118 which is fixedly disposed on a bottom plate 1090 of the pedestal 109. Similarly, the third circuit assembly 118 is, for example, a flexible circuit board, but it is not limited thereto.

As shown in FIG. 4, the driving module DM may further include a second driving assembly DA2, and the second driving assembly DA2 may include a second magnetic element MG2 and a second driving element CL2. The second magnetic element MG2 is, for example, a magnet, and the second driving element CL2 is, for example, a winding coil, but they are not limited thereto.

The second magnetic element MG2 is fixedly disposed on the movable part 108, and the second driving element CL2 is disposed on the third circuit assembly 118, but they are not limited thereto. In other embodiments, the positions of the second magnetic element MG2 and the second driving element CL2 can be interchanged.

The second driving element CL2 is configured to react with the second magnetic element MG2 to generate a second electromagnetic driving force F2 to drive the movable part 108 to move along a first axis AX1 relative to the pedestal 109, and the first axis AX1 is perpendicular to the main axis MX.

Similarly, the driving module DM may further include a third driving assembly DA3, and the third driving assembly DA3 may include a third magnetic element MG3 and a third driving element CL3. The third magnetic element MG3 is, for example, a magnet, and the third driving element CL3 is, for example, a winding coil, but they are not limited thereto.

The third magnetic element MG3 is fixedly disposed on the movable part 108, and the third driving element CL3 is disposed on the third circuit assembly 118, but they are not limited thereto. In other embodiments, the positions of the third magnetic element MG3 and the third driving element CL3 can be interchanged.

The third driving element CL3 is configured to react with the third magnetic element MG3 to generate a third electromagnetic driving force F3 to drive the movable part 108 to move along a second axis AX2 relative to the pedestal 109, and the second axis AX2 is perpendicular to the first axis AX1 and the main axis MX.

In addition, in this embodiment, the driving module DM may further include a fourth driving assembly DA4. The fourth driving assembly DA4 includes a fourth driving element CL4, which is disposed on the third circuit assembly 118 and corresponds to the second driving element CL2. For example, as shown in FIG. 4, the fourth driving element CL4 and the second driving element CL2 are disposed on the same side of the third circuit assembly 118.

Similarly, the fourth driving element CL4 is configured to react with the second magnetic element MG2 to generate a fourth electromagnetic driving force F4. That is, the fourth driving element CL4 and the second driving element CL2 share the same magnetic element (the magnet).

In this embodiment, the currents provided to the fourth driving element CL4 and the second driving element CL2 may be the same or opposite. For example, as shown in FIG. 4, in this embodiment, the fourth electromagnetic driving force F4 and the second electromagnetic driving force F2 have the same amplitude but opposite directions.

Therefore, when the second electromagnetic driving force F2 is opposite to the fourth electromagnetic driving force F4, the second electromagnetic driving force F2 and the fourth electromagnetic driving force F4 are configured to drive the movable part 108 to rotate around the main axis MX relative to the pedestal 109.

On the other hand, when the fourth electromagnetic driving force F4 and the second electromagnetic driving force F2 have the same amplitude and direction, the fourth electromagnetic driving force F4 and the second electromagnetic driving force F2 can cooperatively drive the movable part 108 to move along the first axis AX1.

In addition, as shown in FIG. 4, the movable assembly MA further includes a bottom cover 111 which is fixedly connected to the pedestal 109. The bottom cover 111 is configured to surround at least a portion of the movable part 108, and the bottom cover 111 is configured to protect and limit the range of motion of the movable part 108 along the first axis AX1 or the second axis AX2.

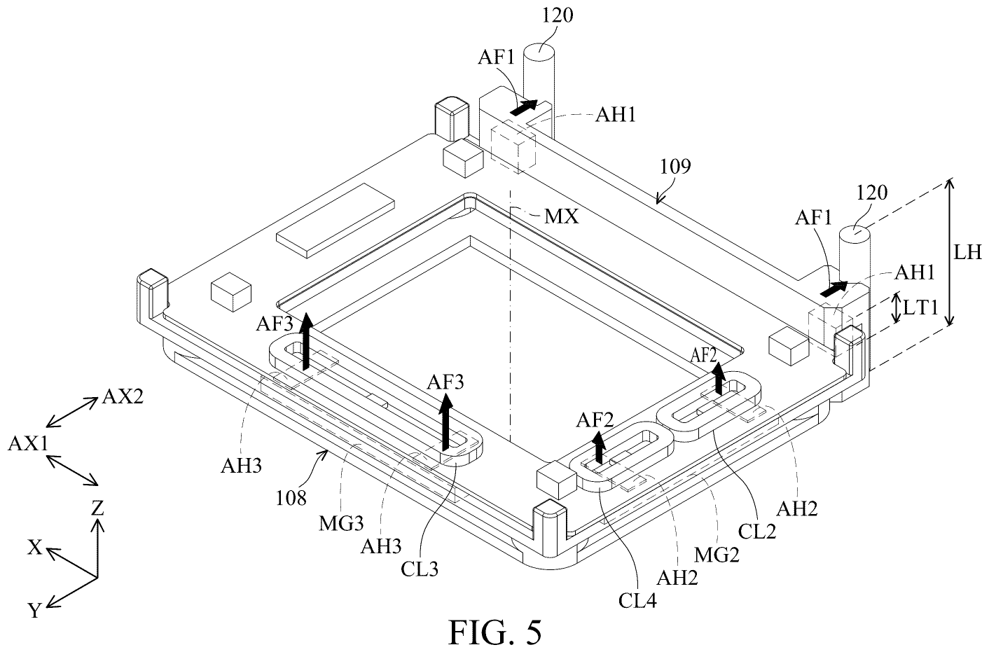

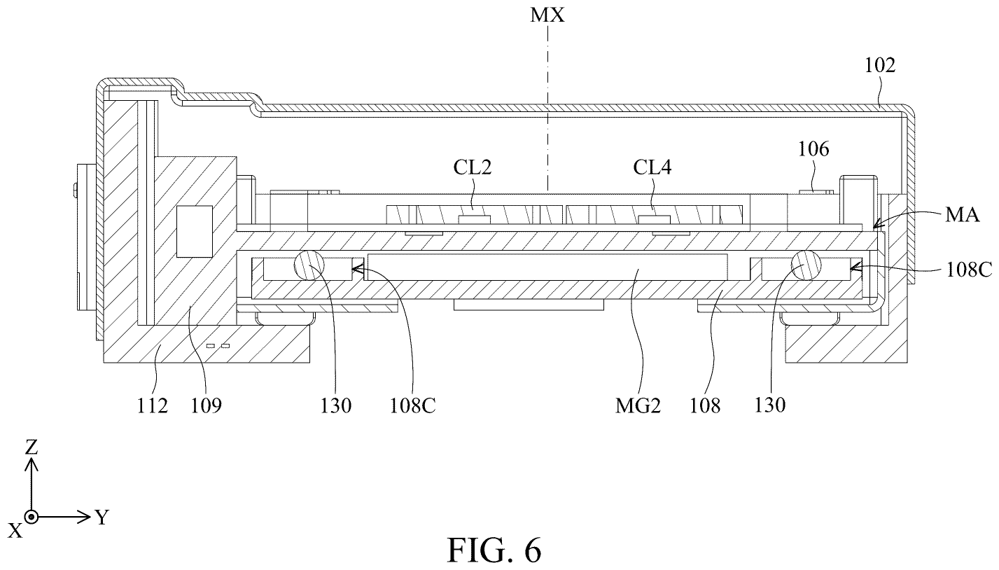

Next, please refer to FIG. 4 to FIG. 6. FIG. 5 is a perspective view of a partial structure of the optical element driving mechanism 100 according to an embodiment of the present disclosure, and FIG. 6 is a cross-sectional view of the optical element driving mechanism 100 along line B-B in FIG. 1 according to an embodiment of the present disclosure.

As shown in FIG. 4 and FIG. 6, the optical element driving mechanism 100 may further include a plurality of second guiding members 130, which are disposed between the pedestal 109 and the movable part 108, and the movable part 108 moves relative to the pedestal 109 by these second guiding members 130. In this embodiment, the optical element driving mechanism 100 may include four second guiding members 130, but they are not limited thereto.

Each of the second guiding members 130 may have a spherical structure, such as a ball, and the movable part 108 may have four accommodation grooves 108C configured to accommodate the second guiding members 130 respectively.

Please continue to refer to FIG. 4 and FIG. 5. In this embodiment, the optical element driving mechanism 100 may further include two first attraction elements AH1, which are disposed in the pedestal 109. The first attraction elements AH1 can be made of magnetic material, such as a magnet, and the corresponding first guiding member 120 can be made of metal.

As shown in FIG. 5, a first magnetic attraction force AF1 can be generated between the first attraction element AH1 and the corresponding first guiding member 120 to drive the pedestal 109 to bear against the first guiding member 120. Based on such a configuration, the movable assembly MA can be more stable when moving along the main axis MX.

It is worth noting that, as shown in FIG. 5, in this embodiment, the length LH of the first guiding member 120 is greater than the length LT1 of the first attraction element AH1 on the main axis MX (the Z-axis). Based on such a design, the stability of the movable assembly MA when moving along the main axis MX can be further ensured. In addition, because the parameters (such as the size, material) of the two first attraction elements AH1 are the same, and the parameters (such as the size, material) of the first guiding members 120 are the same, the amplitudes of the two first magnetic attraction forces AF1 are the same, and they can be applied evenly on the pedestal 109, so that the movable assembly MA can be more stable when moving along the main axis MX.

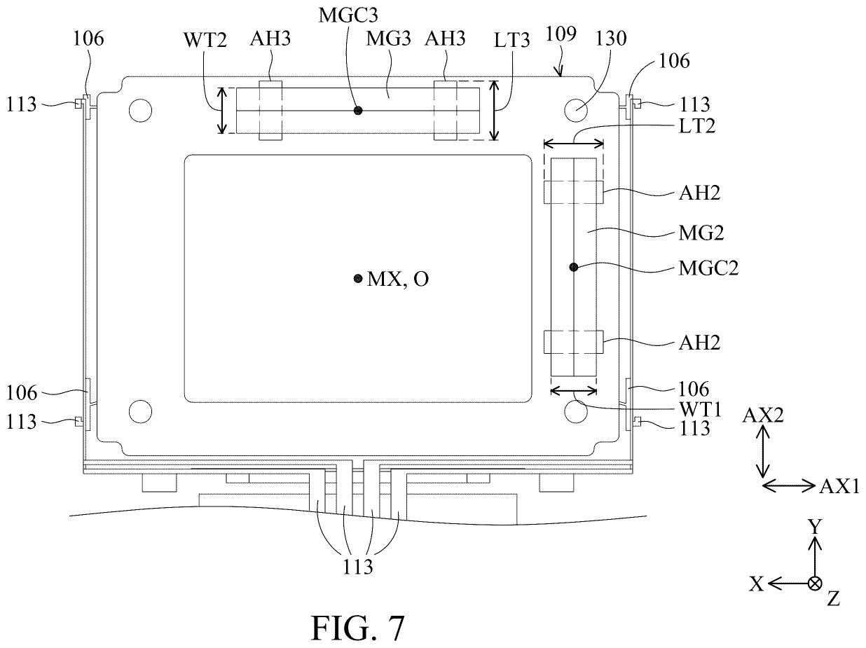

Furthermore, please refer to FIG. 4, FIG. 5 and FIG. 7. FIG. 7 is a bottom view of a partial structure of the optical element driving mechanism 100 according to an embodiment of the present disclosure. As shown in FIG. 4, FIG. 5 and FIG. 7, the optical element driving mechanism 100 may further include two second attraction elements AH2, which are disposed in the pedestal 109 and correspond to the second magnetic element MG2. When viewed along the main axis MX, the two second attraction elements AH2 are arranged along the second axis AX2.

In this embodiment, as shown in FIG. 5 and FIG. 7, when viewed along the main axis MX, each of the two second attraction elements AH2 has a long strip-shaped structure, and the extending direction of the second attraction element AH2 is different from the extending direction of the second magnetic element MG2. Specifically, the extending direction of the second attraction element AH2 (the first axis AX1) is perpendicular to the extending direction of the second magnetic element MG2 (the second axis AX2).

It is worth noting that when viewed along the main axis MX, the length LT2 of the second attraction element AH2 on the first axis AX1 is different from the width WT1 of the second magnetic element MG2 on the first axis AX1. Specifically, when viewed along the main axis MX, the length LT2 of the second attraction element AH2 on the first axis AX1 is greater than the width WT1 of the second magnetic element MG2 on the first axis AX1.

Similarly, the optical element driving mechanism 100 may further include two third attraction elements AH3, which are disposed in the pedestal 109 and correspond to the third magnetic element MG3. When viewed along the main axis MX, the two third attraction elements AH3 are arranged along the first axis AX1.

In this embodiment, when viewed along the main axis MX, each of the two third attraction elements AH3 has a long strip-shaped structure, and the extending direction of the third attraction element AH3 is different from the extending direction of the third magnetic element. Specifically, the extending direction of the third attraction element AH3 (the second axis AX2) is perpendicular to the extending direction (the first axis AX1) of the third magnetic element MG3.

Similarly, when viewed along the main axis MX, the length LT3 of the third attraction element AH3 on the second axis AX2 is different from the width WT2 of the third magnetic element MG3 on the second axis AX2. Specifically, when viewed along the main axis MX, the length LT3 of the third attraction element AH3 on the second axis AX2 is greater than the width WT2 of the third magnetic element MG3 on the second axis AX2.

In this embodiment, the second attraction element AH2 and the third attraction element AH3 may be magnetically conductive sheets, but they are not limited thereto. As shown in FIG. 5, each of the two second attraction elements AH2 and the second magnetic element MG2 can generate a second magnetic attraction force AF2, and each of the two third attraction elements AH3 and the third magnetic element MG3 are configured to generate a third magnetic attraction force AF3.

Based on such a configuration, the movable part 108 can be driven to be suspended at the bottom of the pedestal 109, and the second guiding members 130 can be clamped between the movable part 108 and the pedestal 109, thereby making the movable part 108 to move more stable relatively pedestal 109.

In addition, because the length LT2 of the second attraction element AH2 is greater than the width WT1 of the second magnetic element MG2, and the length LT3 of the third attraction element AH3 is greater than the width WT2 of the third magnetic element MG3, it can be ensured that when the movable part 108 moves, the second magnetic attraction forces AF2 and the third magnetic attraction forces AF3 can maintain stability, so that the movement of the movable part 108 along the XY plane can also be stable.

In addition, because the parameters (the size, material) of the two second attraction elements AH2 are the same, and the shortest distance between each second attraction element AH2 and a center point MGC2 of the second magnetic element MG2 is also the same, Therefore, the two second magnetic attraction forces AF2 have the same amplitude and can be applied evenly on the movable part 108, so that the movement of the movable part 108 relative to the pedestal 109 can be more stable.

Similarly, because the parameters (the size, material) of the two third attraction elements AH3 are the same, and the shortest distance between each third attraction element AH3 and a center point MGC3 of the third magnetic element MG3 is also the same, therefore the two third magnetic attraction forces AF3 have the same amplitude and can be applied evenly on the movable part 108, so that the movement of the movable part 108 relative to the pedestal 109 can be more stable.

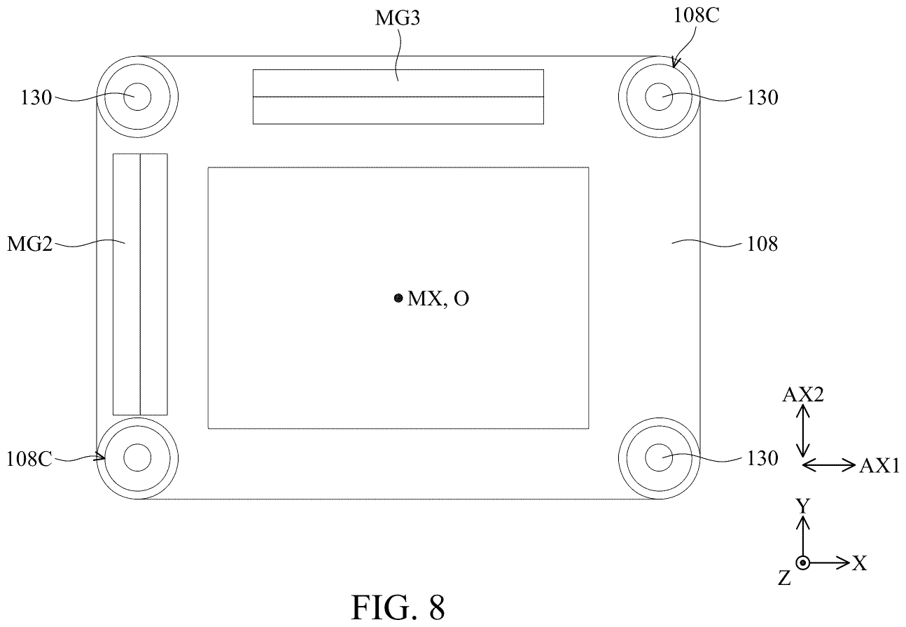

Next, please refer to FIG. 4 and FIG. 8. FIG. 8 is a top view of a partial structure of the optical element driving mechanism 100 according to an embodiment of the present disclosure. As shown in FIG. 4 and FIG. 8, when viewed along the main axis MX, each of the accommodation grooves 108C has a circular structure, and when viewed along the main axis MX, the size of the accommodation groove 108C is greater than the size of the corresponding second guiding member 130.

In this embodiment, the material of the second guiding members 130 may be different from the material of the movable part 108. Therefore, the Young's modulus of these second guiding members 130 may be different from the Young's modulus of the movable part 108.

Specifically, the Young's modulus of these second guiding members 130 is more than ten times of the Young's modulus of the movable part 108. In this embodiment, the movable part 108 can be made of a plastic material, and the second guiding members 130 can be made of ceramic material, but they are not limited thereto.

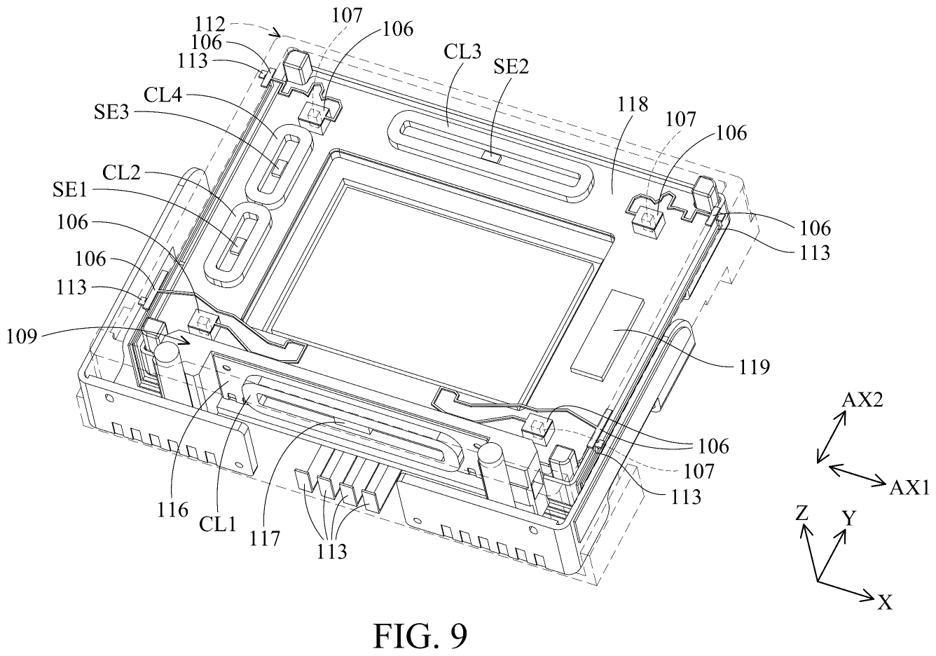

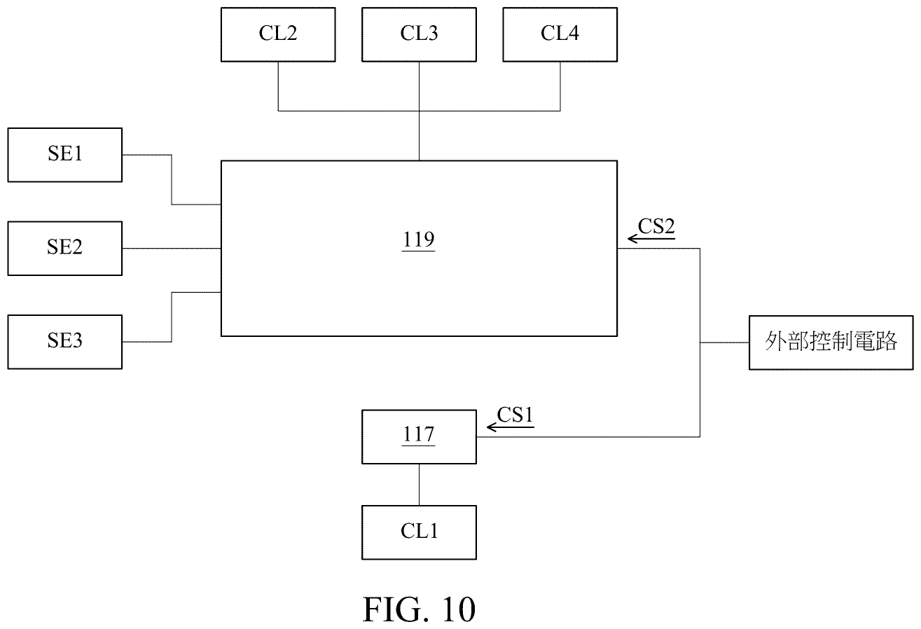

Next, please refer to FIG. 3, FIG. 7, FIG. 9 and FIG. 10. FIG. 9 is a perspective view of a partial structure of the optical element driving mechanism 100 according to an embodiment of the present disclosure, and FIG. 10 is a functional block diagram of a partial structure of the optical element driving mechanism 100 according to an embodiment of the present disclosure. For clarity, the base 112 in FIG. 9 is shown with a dotted line, but is does not mean that the base 112 does not exist. In this embodiment, as shown in FIG. 9, the optical element driving mechanism 100 may further include a first driving circuit 117 and a second driving circuit 119, which are respectively disposed on the second circuit assembly 116 and the third circuit assembly 118.

As shown in FIG. 10, the first driving circuit 117 is electrically connected to the first driving element CL1, and the second driving circuit 119 is electrically connected to the second driving element CL2, the third driving element CL3 and the fourth driving element CL4. In this embodiment, the first driving circuit 117 is, for example, a multi-function integrated circuit (such as the All-In-One IC), and the second driving circuit 119 is, for example, a driver IC, but they are not limited thereto.

Furthermore, as shown in FIG. 3, the optical element driving mechanism 100 further includes a plurality of first conductive members 105 which are disposed in the pedestal 109, and the second circuit assembly 116 is electrically connected to the third circuit assembly 118 through these first conductive members 105. The first conductive members 105 are disposed in the pedestal 109 using insert molding technology, for example. Based on such a configuration, the first driving circuit 117 can be electrically connected to the second driving circuit 119 through the second circuit assembly 116, the first conductive members 105 and the third circuit assembly 118.

As shown in FIG. 7 and FIG. 9, the optical element driving mechanism 100 further includes a plurality of second conductive members 107 which are disposed in the pedestal 109. Furthermore, the optical element driving mechanism 100 of this embodiment includes four elastic members 106 which are movably connected between the pedestal 109 and the base 112, and the elastic members 106 can be made of metal. Therefore, the third circuit assembly 118 can be electrically connected to the four elastic members 106 via the four second conductive members 107 respectively. For example, the end of the second conductive member 107 can be welded to the corresponding elastic member 106.

The optical element driving mechanism 100 may further include a plurality of third conductive members 113 which are partially disposed in the base 112. In this embodiment, the second conductive members 107 and the third conductive members 113 can be made of metal material, and can be disposed in the pedestal 109 and the base 112 respectively by insert molding technology. An end of each third conductive member 113 can be exposed from the base 112 and can be welded to the corresponding elastic member 106, and the other end of each third conductive member 113 is electrically connected to an external control circuit.

Based on such a configuration, the second conductive members 107, the elastic members 106, and the third conductive members 113 can form a plurality of external lines (for example, four lines). Therefore, the first driving circuit 117 and the second driving circuit 119 can share these external lines. That is, as shown in FIG. 10, the first driving circuit 117 and the second driving circuit 119 can be electrically connected to the external control circuit through these external lines. The external control circuit is, for example, a control circuit or a control chip of an electronic device, but it is not limited thereto.

The first driving circuit 117 can control the operation of the first driving element CL1 according to a first control signal CS1 sent by the external control circuit, and the second driving circuit 119 can control the operation of the second driving element CL2, the third driving element CL3 and the fourth driving element CL4 according to a second control signal CS2 sent by the external control circuit.

Furthermore, in this embodiment, because the first driving circuit 117 is a multi-function integrated circuit, the first driving circuit 117 can serve as a sensor configured to sense the movement of the movable assembly MA relative to the base 112. Then, the first driving circuit 117 controls the first driving element CL1 according to the sensing result and the first control signal CS1.

In addition, as shown in FIG. 9 and FIG. 10, the optical element driving mechanism 100 may further include a first sensor SE1, a second sensor SE2 and a third sensor SE3, which are electrically connected to the second driving circuit 119, and the first sensor SE1, the second sensor SE2 and the third sensor SE3 are disposed on the third circuit assembly 118.

The first sensor SE1 is configured to sense the movement of the movable part 108 relative to the pedestal 109 along the first axis AX1, the second sensor SE2 is configured to sense the movement of the movable part 108 relative to the pedestal 109 along the second axis AX2, and the third sensor SE3 is configured to sense the rotation of the movable part 108 relative to the pedestal 109 around the main axis MX.

The second driving circuit 119 controls the second driving element CL2, the third driving element CL3 and the fourth driving element CL4 according to the sensing results of the first sensor SE1, the second sensor SE2 and the third sensor SE3 and the second control signal CS2. The first sensor SE1, the second sensor SE2 and the third sensor SE3 may be Hall sensors, for example, but they are not limited thereto.

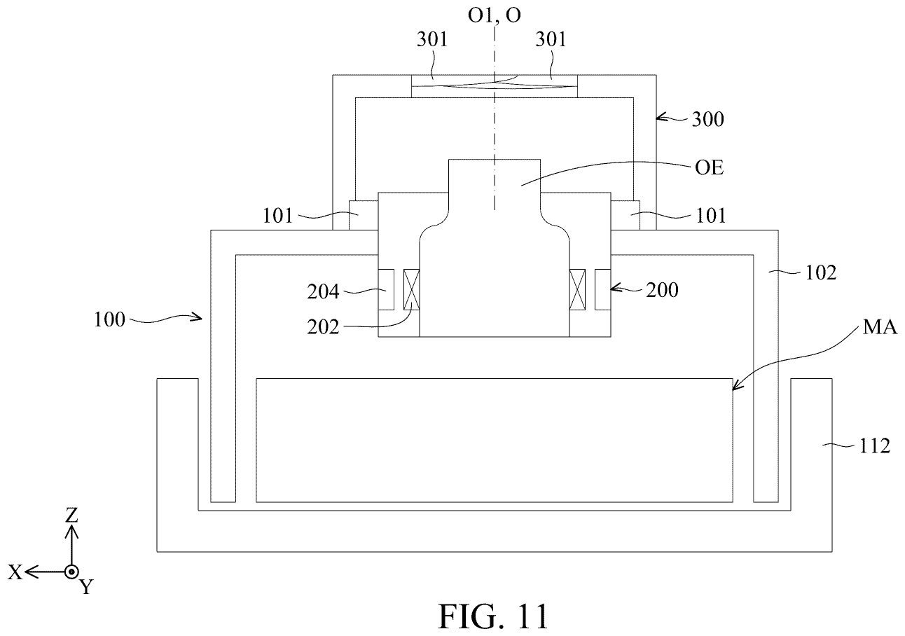

Next, please refer to FIG. 11. FIG. 11 is a schematic front view of a partial structure of the optical element driving mechanism 100 according to an embodiment of the present disclosure. As shown in FIG. 11, the first optical module 200 is detachably connected to the casing 102, and the first optical module 200 has the aforementioned optical element OE (also called the first optical element) and two first driving members 202 and 204.

The first driving members 202 and 204 are configured to drive the first optical element to move relative to the casing 102 along an optical axis O1 of the optical element OE. The optical axis O1 can overlap the aforementioned optical axis O, the first driving member 202 is, for example, a winding coil, and the first driving member 204 is, for example, a magnet, but they are not limited thereto.

Furthermore, the optical element driving mechanism 100 may further include a second optical module 300 and a connecting member 101. The second optical module 300 is detachably connected to the casing 102 via the connecting member 101, and the second optical module 300 can surround at least a portion of the first optical module 200.

The second optical module 300 may have multiple blades 301 to form an aperture structure to adjust the amount of incident light. Furthermore, the connecting member 101 can be disposed on the casing 102 by insert molding technology. For example, the casing 102 is made of metal material, and the connecting member 101 is made of a plastic material, but they are not limited thereto. For example, the connecting member 101 can also be made of rubber material.

In conclusion, the present disclosure provides an optical element driving mechanism 100, which includes a fixed assembly FA, a movable assembly MA and a driving module DM. The movable assembly MA is configured to be connected to an optical element 115, and the driving module DM is configured to drive the movable assembly MA to move relative to the fixed assembly FA. The driving module DM may include a first driving assembly DA1 configured to drive the movable assembly MA to move along the optical axis O relative to the fixed assembly FA so as to achieve the automatic focusing.

In some embodiments, the optical element driving mechanism 100 may further include two first guiding members 120 which are disposed between the base 112 and the movable assembly MA and configured to guide the movable assembly MA to move along the main axis MX relative to base 112. The optical element driving mechanism 100 may further include two first attraction elements AH1, which are disposed in the pedestal 109 of the movable assembly MA. A first magnetic attraction force AF1 can be generated between the first attraction element AH1 and the corresponding first guiding member 120 to drive the pedestal 109 to bear against the first guiding member 120. Based on such a configuration, the movable assembly MA can be more stable when moving along the main axis MX.

In addition, the optical element driving mechanism 100 may further include a plurality of second guiding members 130, the movable assembly MA may have the aforementioned pedestal 109 and a movable part 108, and the movable part 108 can move relative to the pedestal 109 through the second guiding members 130. The driving module DM may include a second driving assembly DA2 and a third driving assembly DA3, which are partially disposed on the pedestal 109. When the optical element driving mechanism 100 is shaken, the second driving assembly DA2 and the third driving assembly DA3 can drive the movable part 108 to move on the X-Y plane to achieve the purpose of optical image stabilization.

Although the embodiments and their advantages have been described in detail, it should be understood that various changes, substitutions, and alterations can be made herein without departing from the spirit and scope of the embodiments as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein can be utilized according to the disclosure. Accordingly, the appended claims are intended to include within their scope such processes, machines, manufacture, compositions of matter, means, methods, or steps. In addition, each claim constitutes a separate embodiment, and the combination of various claims and embodiments are within the scope of the disclosure.

What is claimed is:

1. An optical element driving mechanism, comprising:
a fixed assembly;
a movable assembly, configured to be connected to an optical element, wherein the movable assembly is movable relative to the fixed assembly; and
a driving module, configured to drive the movable assembly to move relative to the fixed assembly.

2. The optical element driving mechanism as claimed in claim 1, wherein
the fixed assembly includes a casing and a base;
the casing and the base are arranged along a main axis;
the optical element driving mechanism further includes a first circuit assembly;
the first circuit assembly has a body portion, and the optical element is disposed on the body portion;
the body portion is connected to the movable assembly;
the first circuit assembly further has a cantilever which is connected between the body portion and the casing; and
the driving module is configured to drive the movable assembly, the body portion and the optical element to move.

3. The optical element driving mechanism as claimed in claim 2, wherein
the driving module includes a first driving assembly configured to drive the movable assembly to move along the main axis;
the movable assembly includes a pedestal and a movable part;
the driving module further includes a second driving assembly configured to drive the movable part to move along a first axis relative to the pedestal;
the driving module further includes a third driving assembly configured to drive the movable part to move along a second axis relative to the pedestal;
the first axis is perpendicular to the main axis; and
the second axis is perpendicular to the first axis and the main axis.

4. The optical element driving mechanism as claimed in claim 3, wherein
the optical element driving mechanism further includes a second circuit assembly which is fixedly disposed on the movable assembly;
the second circuit assembly is disposed on a side wall of the pedestal;
the first driving assembly includes a first magnetic element and a first driving element;
one of the first magnetic element and the first driving element is disposed on the second circuit assembly, and the other one of the first magnetic element and the first driving element is disposed on the base correspondingly; and
the first driving element is configured to react with the first magnetic element to generate a first electromagnetic driving force to drive the movable assembly to move along the main axis.

5. The optical element driving mechanism as claimed in claim 4, wherein
the optical element driving mechanism further includes a third circuit assembly which is disposed on a bottom plate of the pedestal;
the second driving assembly includes a second magnetic element and a second driving element;
one of the second magnetic element and the second driving element is disposed on the third circuit assembly, and the other one of the second magnetic element and the second driving element is disposed on the movable part correspondingly;
the second driving element is configured to react with the second magnetic element to generate a second electromagnetic driving force to drive the movable part to move along the first axis relative to the pedestal;
the third driving assembly includes a third magnetic element and a third driving element;
one of the third magnetic element and the third driving element is disposed on the third circuit assembly, and the other one of the third magnetic element and the third driving element is disposed on the movable part correspondingly; and
the third driving element is configured to react with the third magnetic element to generate a third electromagnetic driving force to drive the movable part to move along the second axis relative to the pedestal.

6. The optical element driving mechanism as claimed in claim 5, wherein
the driving module further includes a fourth driving assembly;
the fourth driving assembly includes a fourth driving element;
the fourth driving element is disposed on the third circuit assembly or the movable part;
the fourth driving element is configured to react with the second magnetic element to generate a fourth electromagnetic driving force; and
when the second electromagnetic driving force is opposite to the fourth electromagnetic driving force, the second electromagnetic driving force and the fourth electromagnetic driving force are configured to drive the movable part to rotate around the main axis.

7. The optical element driving mechanism as claimed in claim 6, wherein
the optical element driving mechanism further includes a first driving circuit and a second driving circuit, which are respectively disposed on the second circuit assembly and the third circuit assembly;
the first driving circuit is electrically connected to the first driving element;
the second driving circuit is electrically connected to the second driving element, the third driving element and the fourth driving element;
the optical element driving mechanism further includes a plurality of first conductive members which are disposed in the pedestal;
the second circuit assembly is electrically connected to the third circuit assembly through the first conductive members; and
the first driving circuit is electrically connected to the second driving circuit through the first conductive members and the third circuit assembly.

8. The optical element driving mechanism as claimed in claim 7, wherein
the optical element driving mechanism further includes a plurality of second conductive members, which are disposed in the pedestal;
the optical element driving mechanism further includes a plurality of elastic members which are movably connected between the pedestal and the base;
the third circuit assembly is electrically connected to the elastic members through the second conductive members;
the optical element driving mechanism further includes a plurality of third conductive members which are partially disposed in the base;
the second conductive members, the elastic members and the third conductive members form a plurality of external lines; and
the first driving circuit and the second driving circuit share the external lines.

9. The optical element driving mechanism as claimed in claim 8, wherein
the first driving circuit and the second driving circuit are electrically connected to an external control circuit through the external lines;
the first driving circuit controls operation of the first driving element according to a first control signal sent by the external control circuit;
the second driving circuit controls operation of the second driving element, the third driving element and the fourth driving element according to a second control signal sent by the external control circuit; and
the first driving circuit is configured to sense movement of the movable assembly relative to the base.

10. The optical element driving mechanism as claimed in claim 9, wherein
the optical element driving mechanism further includes a first sensor, a second sensor and a third sensor, which are electrically connected to the second driving circuit;
the first sensor, the second sensor and the third sensor are disposed on the third circuit assembly;
the first sensor is configured to sense the movement of the movable part along the first axis relative to the pedestal;
the second sensor is configured to sense the movement of the movable part relative to the pedestal along the second axis; and
the third sensor is configured to sense rotation of the movable part relative to the pedestal around the main axis.

11. The optical element driving mechanism as claimed in claim 5, wherein
the optical element driving mechanism further includes a first guiding member disposed between the base and the movable assembly;
the first guiding member is configured to guide the movable assembly to move along the main axis;
the optical element driving mechanism further includes a first attraction element which is disposed in the pedestal;
the first attraction element is made of magnetic material; and
the first guiding member is made of metal.

12. The optical element driving mechanism as claimed in claim 11, wherein
a first magnetic attraction force is generated between the first attraction element and the first guiding member to drive the pedestal to bear against the first guiding member;
the first guiding member has a long strip-shaped structure; and
a length of the first guiding member is greater than a length of the first attraction element on the main axis.

13. The optical element driving mechanism as claimed in claim 12, wherein
the optical element driving mechanism further includes at least one second attraction element which is disposed in the pedestal and corresponds to the second magnetic element;
when viewed along the main axis, the second attraction element has a long strip-shaped structure;
an extending direction of the second attraction element is different from an extending direction of the second magnetic element; and
the extending direction of the second attraction element is perpendicular to the extending direction of the second magnetic element.

14. The optical element driving mechanism as claimed in claim 13, wherein
when viewed along the main axis, a length of the second attraction element on the first axis is different from a width of the second magnetic element on the first axis;
when viewed along the main axis, the length of the second attraction element on the first axis is greater than the width of the second magnetic element on the first axis; and
the second attraction element and the second magnetic element are configured to generate a second magnetic attraction force.

15. The optical element driving mechanism as claimed in claim 14, wherein
the optical element driving mechanism further includes at least one third attraction element, which is disposed in the pedestal and corresponds to the third magnetic element;
when viewed along the main axis, the third attraction element has a long strip-shaped structure;
an extending direction of the third attraction element is different from an extending direction of the third magnetic element; and
the extending direction of the third attraction element is perpendicular to the extending direction of the third magnetic element.

16. The optical element driving mechanism as claimed in claim 15, wherein
when viewed along the main axis, a length of the third attraction element on the second axis is different from a width of the third magnetic element on the second axis;
when viewed along the main axis, the length of the third attraction element on the second axis is greater than the width of the third magnetic element on the second axis; and
the third attraction element and the third magnetic element are configured to generate a third magnetic attraction force.

17. The optical element driving mechanism as claimed in claim 16, wherein
the optical element driving mechanism further includes a plurality of second guiding members, which are disposed between the pedestal and the movable part;
the movable part moves relative to the pedestal through the second guiding members;
the movable part has a plurality of accommodation grooves configured to accommodate the second guiding members respectively;
when viewed along the main axis, each of the accommodation grooves has a circular structure; and
each of the second guiding members has a spherical structure.

18. The optical element driving mechanism as claimed in claim 17, wherein
when viewed along the main axis, a size of the accommodation groove is greater than a size of the corresponding second guiding member;
the material of the second guiding members is different from the material of the movable part;
the Young's modulus of the second guiding members is different from the Young's modulus of the movable part;
the Young's modulus of the second guiding members is more than ten times of the Young's modulus of the movable part;
the movable part is made of a plastic material; and
the second guiding members are made of ceramic materials.

19. The optical element driving mechanism as claimed in claim 1, wherein
the optical element driving mechanism further includes a first optical module, which is detachably connected to a casing of the fixed assembly;
the first optical module has a first optical element and at least one first driving member;
the first driving member is configured to drive the first optical element to move along an optical axis of the first optical element relative to the casing;
the optical element driving mechanism further includes a second optical module and a connecting member; and
the second optical module is detachably connected to the casing via the connecting member.

20. The optical element driving mechanism as claimed in claim 19, wherein
the second optical module surrounds at least a portion of the first optical module;
the second optical module has an aperture structure;
the connecting member is disposed on the casing by insert molding technology;
the casing is made of metal; and
the connecting member is made of a plastic material.
